(19) United States
(12) Patent Application Publication
(10) Pub. No.: US 2017/0043528 A1
(43) Pub. Date: Feb. 16, 2017

(54) RESISTANCE WELDING OF THERMOPLASTIC COMPOSITE COMPONENTS

(71) Applicant: TODS AEROSPACE LIMITED, Somerset (GB)

(72) Inventor: David Conway, Dorset (GB)

(21) Appl. No.: 15/307,010

(22) PCT Filed: Apr. 28, 2015
(86) PCT No.: PCT/GB2015/051228

§ 371 Date: Oct. 27, 2016

(30) Foreign Application Priority Data
Apr. 29, 2014 (GB) 1407487.6

(51) Int. Cl. B29C 65/34

(52) U.S. Cl. CPC B29C 65/34; B29K 2071/00

(57) ABSTRACT

Apparatus (10) and associated method for joining thermoplastic composite components (66, 68) to one another. Firstly, an electrically-conductive carbon-fibre textile (74) is positioned between two pieces of thermoplastic composite (66, 68) to form a weldable assembly (64), and pressure is applied to the weldable assembly (64). A voltage is then applied across the carbon-fibre textile (74) to heat the carbon-fibre textile (74), thereby melting the thermoplastic (82) of a carbon-fibre textile facing surface (78, 80) of each thermoplastic composite (66, 68), wherein the melted thermoplastic (82) fluidly fills the inter-fibre space (84) of the carbon-fibre textile (74). Upon removing the voltage to allow the carbon-fibre textile (74) to cool, a weld (86) forms between the two thermoplastic composites (66, 68) as the thermoplastic sets.

The present invention relates to a method of welding thermoplastic composite components to one another using a resistive welding technique. The invention also relates to an apparatus for implementing such a method, and to a heating element comprising a carbon tissue.

Thermoplastic composite materials are plastic materials comprising a thermoplastic, also known as a thermosoftening plastic, integrated with one or more other materials. Examples of thermoplastics are Polyvinyl Chloride (PVC) and Polytetrafluoroethylene (PTFE). Typically, the other material will be a fibrous compound, for instance, carbon-fibre or fibreglass, thereby adding strength to the composite material.

Whereas thermosetting plastics are irreversibly cured upon being heated past their melting point, thermoplastics can be reversibly set. As a result, thermosetting plastics can form very strong bonds, but can also be brittle. Therefore, thermoplastics may be preferable for certain uses where brittleness could cause issues.

Thermoplastic composites have the potential to be widely used in the aerospace industry, and therefore large components will generally need to be affixed to one another as strongly as possible. There are a number of existing welding techniques available, each with their own specific drawbacks.

The most widely used welding method is induction welding, wherein the thermoplastic composites are heated to melting point at their common interface, and then allowed to cool. This forms a strong weld between the two composites, but the size and shape of the induction head limits the shapes and geometries of composite components which can be welded together.

Laser welding can also be used; since a laser beam is used, the geometry of the components is less important. However, laser welding is ineffective when used in combination with carbon-fibre composite materials, and there is a limit to its effectiveness when used with glass-based materials.

The third technique available is resistive welding, wherein a voltage is applied to an interstitial component between the two thermoplastic composite components, and a pressure is applied to force the assembly together. The heating of the interstitial component melts the thermoplastic components, and forms a weld.

Typically, the interstitial component is a metal mesh. However, using metal decreases the strength and fatigue resistance of the weld, and also increases the damage caused by lightning strike. This is of particular importance in the aerospace industry. Alternatively, continuous carbon fibre can be used. However, the carbon fibre leads to low quality welds, in particular, voids form in the weld which create substantial weaknesses.

The present invention seeks to provide a solution to the above-mentioned problems of the resistance welding technique.

According to a first aspect of the invention, there is provided a method for joining thermoplastic composite components to one another, comprising the steps of: a) positioning an electrically-conductive non-metal pliantly flexible membrane between two pieces of thermoplastic composite to form a weldable assembly; b) applying pressure to the weldable assembly; c) applying a voltage across the flexible membrane to heat the flexible membrane, thereby melting the thermoplastic of a flexible membrane facing surface of each thermoplastic composite, wherein the melted thermoplastic fluidly fills the inter-fibre space of the flexible membrane; and d) removing the voltage to allow the flexible membrane to cool, a weld forming between the two thermoplastic composites as the thermoplastic sets.

Preferably, the flexible membrane may be carbon-fibre textile, preferably still a non-woven textile and most preferably may be a carbon tissue. By way of definition, a carbon tissue is any non-woven carbon-fibre based textile which is bonded together in a random fibre matrix, typically less than 100 microns in thickness, which is porous to thermoplastic or resin-based liquids.

The present invention seeks to improve the effectiveness of welding two thermoplastic composite components to one another. Rather than utilising thermosetting components, which may be brittle, the thermoplastic at the surface of the components advantageously melts during the welding process. This causes ‘wetting out’ of the carbon-fibre textile, that is to say, filling the interstitial voids of the textile with melted thermoplastic, which then solidifies to form the weld. By using a carbon-fibre textile, as opposed to continuous carbon fibres, it is possible to avoid the formation of weakening voids in the weld.

A carbon tissue is a preferred heating element for use in the method; it is sufficiently resistive so as to be readily heated under the application of a voltage, and the interstitial spaces between the carbon fibres of the tissue can be easily ‘wetted out’ without causing the formation of voids, as is the case with continuous carbon fibres. When the thermoplastic sets, the carbon tissue will greatly increase the strength of the weld with minimal weight gain to the finished product.

At least one, and preferably both, of the thermoplastic composite components may be a continuous fibre-based laminate material. Alternatively, one of the thermoplastic composite components may be a discontinuous fibre-based laminate material, a powder-filled thermoplastic, or an unfilled thermoplastic.

The thermoplastic of the thermoplastic composite components may preferably be

Polyether Imide, Poly Ether Ether Ketone or Polyphenylene Sulfide.

Thermoplastic composite components have the potential to be widely used in the aerospace industry, and it is beneficial to be able to provide a method of welding disparate components together, without causing structural weaknesses within the final assembly. By using the thermoplastic of the components themselves as the weld material, a clean uniformly continuous join between the components is formed.

The optimum materials for resistive welding according to the present invention are continuous fibre-based laminate materials, being the strongest form of composites. However, it may be necessary to weld other types of thermoplastic material to said components, and this method is equally applicable for such uses.

Preferably, during step a) of the aforestated method, electrically-insulative layers may be inserted between the thermoplastic composite components and the flexible membrane. The electrically-insulative layers may preferably be formed from single-ply glass thermoplastic composite. Other thermoplastic materials may also be considered or utilised.

Electrical insulation of the thermoplastic composite components from the voltage being passed through the flexible membrane prevents electrical conduction through the composite components. If the components were in electrical communication with the flexible membrane, then it is possible that the composite components could also heat or be unduly heated, thus causing melting or softening of thermoplastic in areas which were not part of the weld. For safety reasons, it is therefore advantageous to electrically separate the thermoplastic composite components from the flexible membrane.

Whilst the thermoplastic composite components may be electrically conductive due to the presence of the carbon fibre reinforcement, the thermoplastic itself is not electrically conductive. Therefore, even if the electrically-insulative layers are formed from glass thermoplastic composite, the thermoplastic composite components will be isolated from the electrical connection.

According to a second aspect of the invention, there is provided a component formed from two thermoplastic composite components welded to one another in accordance with the first aspect of the invention. Preferably, the component is an aircraft component.

A thermoplastic composite component formed by the welding together two thermoplastic composite components utilising an electrically-conductive non-metal pliantly flexible membrane as a heating element will have increased strength and fatigue-resistance when compared with a weld utilising a metal mesh. This can be most advantageously applied to the aerospace industry.

According to a third aspect of the invention, there is provided a resistance welding apparatus for use with the method according to the first aspect of the invention comprising: first and second toolings, between which the weldable assembly is positionable; first and second electrodes; and a power supply; wherein at least one of first and second toolings is actuatable towards the other, actuation of the or each tooling towards the other applying pressure to the weldable assembly; and wherein first and second electrodes are spaced apart so as to contact with the flexible membrane of the weldable assembly, the first and second electrodes being in electrical communication with the power supply, thereby supplying a voltage across the flexible membrane to achieve a welding condition.

A welding apparatus for use with a method according to the first aspect of the invention advantageously accommodates a heating element which is a flexible member, as previously described. In particular, the electrodes may be separated by a distance approximately equal to the length of the flexible member.

Preferably, the second tooling is positioned above the first tooling, the second tooling being actuatable towards the first tooling.

Arranging the first and second toolings such that there are upper and lower toolings, the upper tooling being raised or lowered towards the lower tooling, ensures that pressure is evenly applied to the weldable assembly during the weld process.

Preferably, the first and second electrodes may be affixed to the first tooling. Also preferably, the first and second electrodes may each comprise a rigid support electrode and a flexible foil electrode, the rigid support electrode being affixed to the first tooling, and the flexible foil electrode being attached to the rigid support electrode, the flexible foil electrode contacting the flexible membrane.

Electrodes having both a rigid portion and a flexible portion allows for the weldable assembly to be assembled without difficulty within the apparatus, the flexible electrodes then being easily contactable with the ends of the flexible membrane to complete an electrical circuit.

The apparatus may preferably further comprise a computer control device for controlling at least the pressure application of the or each actuatable tooling.

By providing a single operating unit for the apparatus, the pressure and voltage applications may be simultaneously operable by a user. This advantageously allows for greater automation of the welding procedure, increasing the throughput of the apparatus.

Furthermore, the apparatus may preferably additionally or alternatively comprise at least one electrical safety device to override the actuation of the or each tooling.

It is important that the weldable assembly is not over-pressurised by the or each actuatable tooling during the welding process, since this can result in damage to the thermoplastic composite components. Therefore, electrical safety devices can be installed to be activated if the toolings are too close to one another; in other words, if too great a pressure is being applied to the weldable assembly.

According to a fourth aspect of the invention, there is provided a heating element for use with a resistance welding apparatus according to the third aspect of the invention, the heating element comprising the flexible membrane.

Preferably, the flexible membrane may be laminated between two electrically-insulative layers, and further preferably the electrically-insulative layers may be formed from single-ply glass. thermoplastic composite.

By providing an easily manufactured heating element which can be readily installed between thermoplastic composite components during the welding process, the throughput of the apparatus can be increased. The heating element can be advantageously sized so as to readily contact with the electrodes of the apparatus when the weldable assembly is in position.

This heating element could therefore be provided simply as a carbon tissue, or could more advantageously be provided with the electrically-insulative layers pre-attached. With such a heating element, the weldable assembly is more easily assembled, and therefore the apparatus reduces the required set-up time between welds.

The invention will now be more particularly described, by way of example only, with reference to the accompanying drawings, in which:

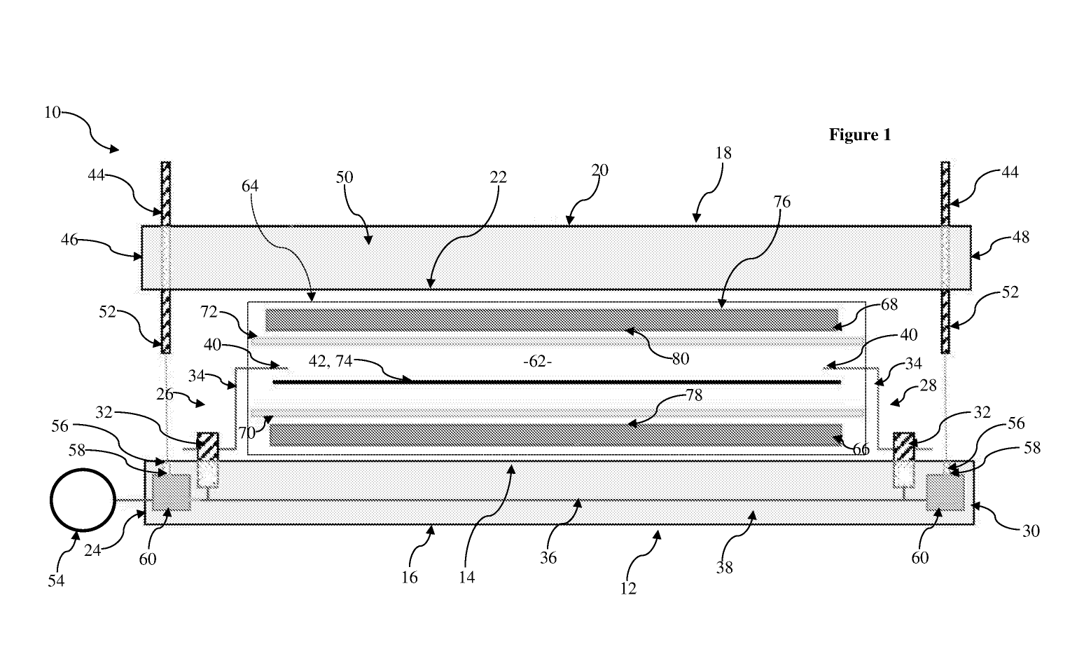

FIG. 1 shows a diagrammatic cross-sectional view through a first embodiment of the apparatus in accordance with the second aspect of the invention;

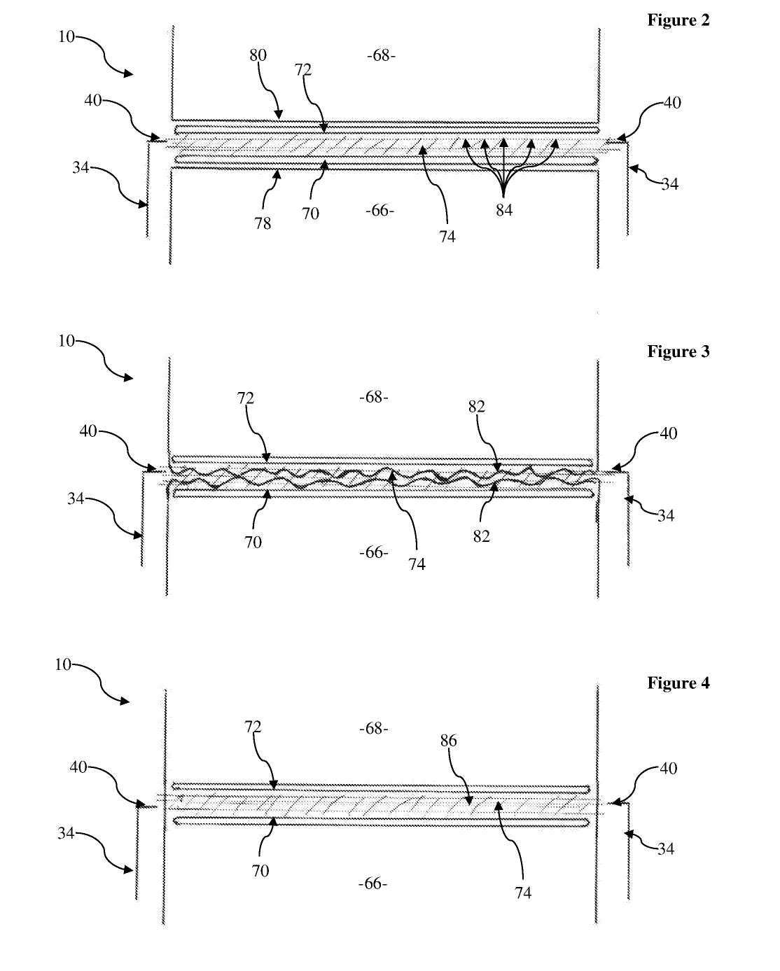

FIG. 2 shows a diagrammatic side-view representation of a welding assembly being welded in accordance with the first aspect of the invention, prior to heating;

FIG. 3 shows the welding assembly of FIG. 2, during heating; and

FIG. 4 shows the welding assembly of FIG. 3, following cooling.

Referring firstly to FIG. 1 there is shown an apparatus for resistance welding of thermoplastic composite components, indicated globally at 10. The apparatus comprises a cuboidal first tooling 12 having top and bottom planar faces 14, 16, and a complementarily sized second tooling 18, also having top and bottom planar faces 20, 22. Both first and second toolings 12, 18 are substantially elongate along a horizontal axis. The first and second toolings 12, 18 are positioned in a stacked arrangement relative to one another, the second tooling 18 being positioned above the first tooling 12.

Towards a first end 24 of the first tooling 12 is positioned a first electrode 26, projecting upwardly from the top face 14 of the first tooling 12. A second electrode 28, also projecting upwardly from the top face 14 of the first tooling 12, is positioned at the opposing end 30. Each electrode 26, 28 comprises a rigid electrically-conductive support 32 which is affixed to the first tooling 12, and a flexible electrically-conductive foil 34.

Electrical power is supplied to each of the first and second electrodes 26, 28 via connection to an electrical connector 36 within the body 38 of the first tooling 12.

Each flexible electrically-conductive foil 34 extends upwardly from its rigid electrically-conductive support 36 and has a distal tang 40 which is aligned towards the distal tang of the opposing electrode. The tangs 40 are spaced apart from one another so as to be able to receive a heating element 42 for use in the apparatus 10.

The second tooling 18 is affixed to a plurality of plungers or guides 44, at least one plunger 44 being positioned at each longitudinal end 46, 48 of the second tooling 18, and the plungers 44 being vertically actuatable. Each plunger 44 extends through the body 50 of the second tooling 18, and a projecting shaft 52 of each plunger 44 extends from the bottom planar face 22 of the second tooling 18 towards the first tooling 12.

The plungers 44 may be hydraulically operated pistons, or any other similarly actuatable devices, such as screw-threaded bits and/or rams. The plungers may alternatively be simply guides along which the second tooling is movable, with one or more rams or other suitable actuator, such as a hydraulic, pneumatic or electrically-drivable piston, being utilised to move the second tooling. A computer controller may be provided to allow a user to control and monitor the or each plungers or actuator, at least.

The first tooling 12 is connected with a power supply 54 which provides electrical power to the apparatus 10 via a series of electrical connectors 36 embedded within the body 38 of the first tooling 12. The power supply 54 is preferably an AC power supply, supplying a controlled low voltage, and the electrical connectors 36 connect to the electrically operable components of the apparatus 10. The computer controller may also be utilised to control and monitor the voltage and/or temperature of the heating element 42.

The plungers 44 enable the second tooling 18 to be actuated and thus moved towards the first tooling 12. In the top face 14 of the first tooling 12 is provided a series of complementary recesses 56 for receiving the projecting shafts 52 of the plungers 44. As a safety measure, inside the body 38 of the first tooling 12 at the innermost ends 58 of the recesses 56 are provided one or more electrical safety devices 60, which are activatable upon contact with the projecting shafts 52.

The area between the first and second toolings 12, 18 and between the first and second electrodes 26, 28 may therefore be termed the weldable assembly receiving area 62. This may or may not be demarcated or otherwise indicated on either the first tooling 12, second tooling 18 or both.

A weldable assembly 64 comprises first and second thermoplastic composite components 66, 68, first and second electrically-insulative layers 70, 72 and an electrically-conductive non-metal pliantly flexible membrane, in this case being a carbon-fibre textile 74. The assembly 64 is formed in layers, from the lowest level upwards: the first thermoplastic composite component 66; the first electrically-insulative layer 70; the electrically-conductive carbon-fibre textile 74; the second electrically-insulative layer 72; and the second thermoplastic composite component 68.

The electrically-conductive carbon-fibre textile 74 is a non-woven textile, preferably a carbon tissue. Such an electrically-conductive carbon-fibre textile 74 is used in preference to a continuous carbon-fibre, as is presently used in the industry. Continuous carbon-fibres encourage the formation of voids in the weld; areas in which there is no thermoplastic material. As such, the weld is significantly weakened. When utilising an electrically-conductive carbon-fibre textile 74, such voids are not formed.

The thermoplastic composite components 66, 68 are preferably both continuous fibre-based laminate materials, having continuous carbon or glass fibres embedded within a thermoplastic material, preferably Polyether Imide (PEI), Poly Ether Ether Ketone (PEEK) or Polyphenylene Sulfide (PPS). The strongest welds are achievable for components 66, 68 which are continuous fibre-based laminate materials; however, the present welding technique can be applied to any of discontinuous fibre-based materials, powder-filled thermoplastic or unfilled thermoplastics, provided an outermost layer of the material is thermoplastic.

The first and second electrically-insulative layers 70, 72 are preferably formed from a single-ply glass thermoplastic composite.

To weld the thermoplastic composite components 66, 68 of the weldable assembly 64 together, the layers are assembled as detailed above inside the weldable assembly receiving area 62. The distal tangs 40 of the flexible electrically-conductive foils 34 of the first and second electrodes 26, 28 are contacted with respective ends of the electrically-conductive carbon-fibre textile 74. In this case, the electrically-conductive carbon-fibre textile 74 is the standard heating element 42, and therefore the tangs 40 are separated by a distance approximately equal to the length of the electrically-conductive carbon-fibre textile 74.

Once the weldable assembly 64 is in place, the plungers 44 are activated to lower the second tooling 18 towards the first tooling 12. The bottom face 22 of the second tooling 18 will come into contact with an upper surface 76 of the second thermoplastic composite component 68, thereby applying a downward force to the weldable assembly 64, compressing the layers together.

Once the desired force is reached, the power supply 54 can be activated to supply a voltage across the electrically-conductive carbon-fibre textile 74. This will result in heating of the electrically-conductive carbon-fibre textile 74, which will initiate the welding of the two thermoplastic composite components 66, 68.

Both the plungers 44, and therefore pressure application, and the power supply 54, and therefore welding voltage, may be controlled by a single computer control device. This advantageously enables a single control unit to be installed, allowing control of the welding process as a whole. Such computer control device is known, and therefore will not be described in further detail.

The welding process is controlled by the temperature of the electrically-conductive carbon-fibre textile 74. This is depicted in FIGS. 2 to 4. As the temperature of the electrically-conductive carbon-fibre textile 74 rises, the thermoplastic at the welding interfaces 78, 80 of the first and second thermoplastic composite components 66, 68 will begin to melt.

The voltage to the electrically-conductive carbon-fibre textile 74 is carefully controlled to ensure that its temperature is at or is close to the melting point of the thermoplastic, the thermoplastic composite components 66, 68 being electrically insulated by the first and second electrically-insulative layers 70, 72. This ensures that only the thermoplastic at the welding interfaces 78, 80 melts, rather than the entire thermoplastic composite component 66, 68.

As the thermoplastic at the welding interfaces 78, 80 melts, the pressure supplied by second tooling 18 on the second thermoplastic composite component 68 forces the first and second components 66, 68 together. The melted layer of thermoplastic 82 then fills the interstitial spaces 84 in the conductive carbon-fibre textile 74, wetting out the tissue and thereby forming a liquid join between the first and second components 66, 68.

As the voltage is removed from the apparatus 10, the electrically-conductive carbon-fibre textile 74 will cool, and the liquid thermoplastic 82 will begin to set. As the thermoplastic sets, it will form a solid, contiguous weld 86 between the first and second thermoplastic composite components 66, 68 with the carbon tissue 74 sandwiched therebetween. The plungers 44 can then be retracted to release the pressure on the weldable assembly 64, and the now-welded assembly can be removed from the apparatus 10.

The electrically-insulative layers 70, 72 may be formed from a glass thermoplastic composite, whereby the thermoplastic will also melt during the welding process.

The apparatus 10 is preferably further provided with an override mechanism in the form of the electrical safety devices 60. If too much pressure is applied through the plungers 44 and the force on the weldable assembly 64 becomes too great, then the projecting shafts 52 of the plungers 44 locate in the complementary recesses 56, thereby activating the safety devices 60. This will cause the apparatus 10 to shut down or the toolings to separate, in order to prevent damage to the components of the weldable assembly 64.

It will be appreciated that a large proportion of the method of welding thermoplastic composite components as described is dependent not only upon the provision of both the first and second thermoplastic composite components 66, 68 to be welded, but also upon the electrically-conductive carbon-fibre textile 74.

Since the electrically-conductive carbon-fibre textile 74 must fit into the apparatus 10 between the first and second electrodes 26, 28 during normal operation, it is an intention of the present invention to provide a heating element 42 compatible with the apparatus 10 which comprises such an electrically-conductive carbon-fibre textile 74.

Using such a replaceable heating element 42 allows for many different thermoplastic composite components to be welded together about a single type of electrically-conductive carbon-fibre textile 74. This increases the versatility of the apparatus 10.

Although a carbon-fibre textile, in the form of a tissue, is suggested, any suitable, preferably non-metal and/or pliantly flexible, electrically conductive sheet, membrane or layer may be utilised.

More advantageously, the electrically-conductive carbon-fibre textile 74 could be provided in combination with both first and second electrically-insulative layers 70, 72 as a single heating element 42. Provision of such a heating element 42 therefore removes the need to assemble five layers in the weldable assembly 64, which will speed up the welding process, and also reduce the probability of incorrect layering of the various components of the weldable assembly 64.

Thermoplastic composite components formed as a result of the method can be used in a variety of industries. In particular, the present method is intended for use in the aerospace industry, advantageously providing the necessary strength to welded components through use of the electrically-conductive non-metal pliantly flexible membrane. However, the method described is widely applicable.

It will be appreciated that it may be desirable to weld thermoplastic composite components together of different volumes. It may therefore be advantageous to provide electrodes in the first tooling of the apparatus which can accommodate a plurality of component sizes and shapes. This may be achieved by providing movable first and second electrodes, thereby being able to accommodate differently sized heating elements.

The welding process is also described as being utilised to combine two thermoplastic composite components; however, the process could conceivably be used to combine more than two components together at a single joint, if desired. Additionally or alternatively, other kinds of thermoplastic may be utilised, and/or a thermoplastic without glass may be utilised.

Whilst the plungers are described as being affixed to the second tooling of the apparatus, it will be understood that the important feature is the application of pressure to the weldable assembly during the resistance welding process, and therefore, the first tooling could be constructed in a similar manner so as to provide said pressure.

It will be apparent to the skilled person that there are numerous additional features known in the art which could be added to the apparatus in order to improve its performance. In particular, safety features such as additional pressure, temperature or voltage overrides could be included, in order to comply with regulatory guidelines.

It is therefore possible to provide a method of resistively welding thermoplastic composite components to one another, using a carbon-fibre textile as a heating element. The carbon-fibre textile heats and subsequently melts the thermoplastic interfaces of the composite components, ‘wetting out’ the textile with molten thermoplastic. Upon setting of the thermoplastic, the two thermoplastic composite components will be joined. The utilisation of the textile results in the formation of a void-free weld, resulting in a strong bond between the two components.

The words ‘comprises/comprising’ and the words ‘having/including’ when used herein with reference to the present invention are used to specify the presence of stated features, integers, steps or components, but do not preclude the presence or addition of one or more other features, integers, steps, components or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A method for joining thermoplastic composite components to one another, comprising the steps of:
a) positioning an electrically-conductive non-metal pliantly flexible membrane between two pieces of thermoplastic composite to form a weldable assembly;
b) applying pressure to the weldable assembly;
c) applying a voltage across the flexible membrane to heat the flexible membrane, thereby melting the thermoplastic of a flexible membrane facing surface of each thermoplastic composite, wherein the melted thermoplastic fluidly fills the inter-fibre space of the flexible membrane; and
d) removing the voltage to allow the flexible membrane to cool, a weld forming between the two thermoplastic composites as the thermoplastic sets.

2. A method as claimed in claim 1, wherein the flexible membrane is a carbon-fibre textile.

3. A method as claimed in claim 1, wherein the flexible membrane is a non-woven textile.

4. A method as claimed in claim 2, wherein the carbon-fibre textile is a carbon tissue.

5. A method as claimed in claim 1, wherein at least one of the thermoplastic composite components is a continuous fibre-based laminate material.

6. A method as claimed in claim 5, wherein one of the thermoplastic composite components is one of: a discontinuous fibre-based laminate material; a powder-filled thermoplastic; and an unfilled thermoplastic.

7. (canceled)

8. (canceled)

9. A method as claimed in claim 1, wherein the thermoplastic of the thermoplastic composite components is Polyether Imide.

10. A method as claimed in claim 1, wherein the thermoplastic of the thermoplastic composite components is Poly Ether Ether Ketone.

11. A method as claimed in claim 1, wherein the thermoplastic is Polyphenylene Sulfide.

12. A method as claimed in claim 1, wherein, during step a) electrically-insulative layers are inserted between the thermoplastic composite components and the flexible membrane.

13. A method as claimed in claim 12, wherein the electrically-insulative layers are formed from single-ply glass thermoplastic composite.

14. (canceled)

15. (canceled)

16. A resistance welding apparatus for use in a method as claimed in claim 1, the apparatus comprising:
first and second toolings, between which the weldable assembly is positionable;
first and second electrodes; and
a power supply;
wherein at least one of first and second toolings is actuatable towards the other, actuation of the or each tooling towards the other applying pressure to the weldable assembly; and
wherein first and second electrodes are spaced apart so as to contact with the flexible membrane of the weldable assembly, the first and second electrodes being in electrical communication with the power supply, thereby supplying a voltage across the flexible membrane to achieve a welding condition.

17. A resistance welding apparatus as claimed in claim 16, wherein the second tooling is positioned above the first tooling, the second tooling being actuatable towards the first tooling.

18. A resistance welding apparatus as claimed in claim 16, wherein the first and second electrodes are affixed to the first tooling.

19. A resistance welding apparatus as claimed in claim 18, wherein the first and second electrodes each comprise a rigid support electrode and a flexible foil electrode, the rigid support electrode being affixed to the first tooling, and the flexible foil electrode being attached to the rigid support electrode, the flexible foil electrode contacting with the flexible membrane.

20. A resistance welding apparatus as claimed in claim 16, further comprising a computer control device for controlling at least the pressure application of the or each actuatable tooling.

21. A resistance welding apparatus as claimed in claim 16, further comprising at least one electrical safety device to override the actuation of the or each tooling.

22. A heating element for use with a resistance welding apparatus as claimed in claim 16, the heating element comprising the flexible membrane.

23. A heating element as claimed in claim 22, the heating element further comprising two electrically-insulative layers laminated onto the flexible membrane.

24. A heating element as claimed in claim 23, wherein the electrically-insulative layers are formed from single-ply glass thermoplastic composite.
